(19) United States
(12) Patent Application Publication
(10) Pub. No.: US 2026/0219813 A1
(43) Pub. Date: Jul. 30, 2026

(54) IMAGE FORMING APPARATUS, IMAGE FORMING METHOD, AND STORAGE MEDIUM

(71) Applicant: CANON KABUSHIKI KAISHA, Tokyo (JP)

(72) Inventor: HIDESHI ICHIMI, Ibaraki (JP)

(21) Appl. No.: 19/457,445

(22) Filed: Jan. 23, 2026

(30) Foreign Application Priority Data
Jan. 28, 2025 (JP) 2025-012071

(51) Int. Cl. G06F 3/12; G03G 15/00

(52) U.S. Cl. CPC G06F 3/1207; G03G 15/5012; G03G 15/502; G06F 3/121; G06F 3/1234; G06F 3/1273

(57) ABSTRACT

An image forming apparatus includes: a managing unit configured to manage solution information related to a solution implemented to resolve an issue that has occurred along with execution of a job in the image forming apparatus such that the solution information is associated with the issue; and a display controlling unit configured to display, on a display unit, a troubleshooting target job so as to be selectable by a user operation among at least one job executed in the image forming apparatus. The display controlling unit displays, on the display unit, the solution information associated with an issue corresponding to an issue that has occurred along with execution of the job selected by the user operation, among at least one issue managed in the managing unit.

### BACKGROUND

### Field of the Technology

The technology of the present disclosure relates to a troubleshooting technology for a print job.

### DESCRIPTION OF THE RELATED ART

In a case where a printing issue such as an abnormal termination exit occurs during printing performed using a multifunction printer, the user takes action following the troubleshooting guide in a manual or requests a service engineer to repair the multifunction printer.

Japanese Patent Laid-Open No. 2012-163805 discloses a technology that displays solutions for an issue occurring on an image forming apparatus and sets image forming conditions based on the solution selected by the user.

### SUMMARY

An image forming apparatus according to an aspect of the technology of the present disclosure includes at least one memory that stores instructions; and at least one processor that executes the instructions to: manage solution information related to a solution implemented to resolve an issue that has occurred along with execution of a job in the image forming apparatus such that the solution information is associated with the issue; and display, on a display unit, a troubleshooting target job so as to be selectable by a user operation among at least one job executed in the image forming apparatus, wherein, in the displaying, the solution information associated with an issue corresponding to an issue that has occurred along with execution of the job selected by the user operation, among at least one issue managed in the managing, is displayed on the display unit.

Features of the present disclosure will become apparent from the following description of embodiments with reference to the attached drawings. The following description of embodiments are described by way of example.

### BRIEF DESCRIPTION OF THE DRAWINGS

FIG. 1 is a block diagram illustrating a configuration example of an image forming system;

FIG. 2 is a diagram illustrating an example of a software configuration of an image forming apparatus;

FIG. 3 is a flowchart illustrating a flow of a storing process for a job log;

FIG. 4 is a diagram illustrating an example of a job log;

FIG. 5 is a flowchart illustrating a flow of a troubleshooting process for a printing issue;

FIG. 6 is a diagram illustrating an example of a troubleshooting menu screen;

FIG. 7 is a diagram illustrating an example of a screen displaying a job list related to a printing issue;

FIG. 8 is a flowchart illustrating a detailed flow of a display process for a job list of a printing issue;

FIG. 9 is a diagram illustrating an example of a candidate job extraction table;

FIG. 10 is a flowchart illustrating a detailed flow of a display process for target job;

FIG. 11 is a diagram illustrating a job troubleshooting execution result list;

FIG. 12 is a diagram showing the relationship of FIGS. 12A and FIG. 12B;

FIGS. 12A and 10B are diagrams illustrating a list of solutions to printing issues;

FIG. 13 is a diagram illustrating a detailed example of the job troubleshooting execution results;

FIG. 14 is a diagram illustrating an example of a screen displaying solution candidates and the details of a solution;

FIG. 15 is a flowchart illustrating a detailed flow of a register process for a troubleshooting execution result;

FIG. 16 is a diagram illustrating an example of a screen displayed for registering the execution result of a displayed solution;

FIG. 17 is a diagram illustrating a detailed example of the job troubleshooting execution results after registering the execution results of solutions;

FIG. 18 is a diagram illustrating a detailed example of the job troubleshooting execution results after registering the execution results of solutions;

FIG. 19 is a flowchart illustrating a detailed flow of a display process for a job list of a printing issue; and

FIG. 20 is a diagram illustrating an example of a screen displaying a job list related to a printing issue.

### DESCRIPTION OF THE EMBODIMENTS

Hereinafter, a description is given about embodiments of the technology of the present disclosure with reference to the drawings. Note that the following embodiments are not intended to limit the technology of the present disclosure related to the scope of the patent claims. Not all combinations of the features described in the present embodiments are essential to the solutions provided as the technology of the present disclosure, and multiple features may be combined in any desired manner. In the description, the same reference numerals are assigned to the same configurations. Further, each process (step) in a flowchart is prefixed with "S".

### First Embodiment

In the present embodiment, an image forming apparatus that allows viewing of both setting information and solutions is described as an example. In the present embodiment, a description is given about a mode in which, in troubleshooting an issue that has occurred in an image forming apparatus along with execution of a print job, a solution for the issue is displayed and an execution result of the solution is registered.

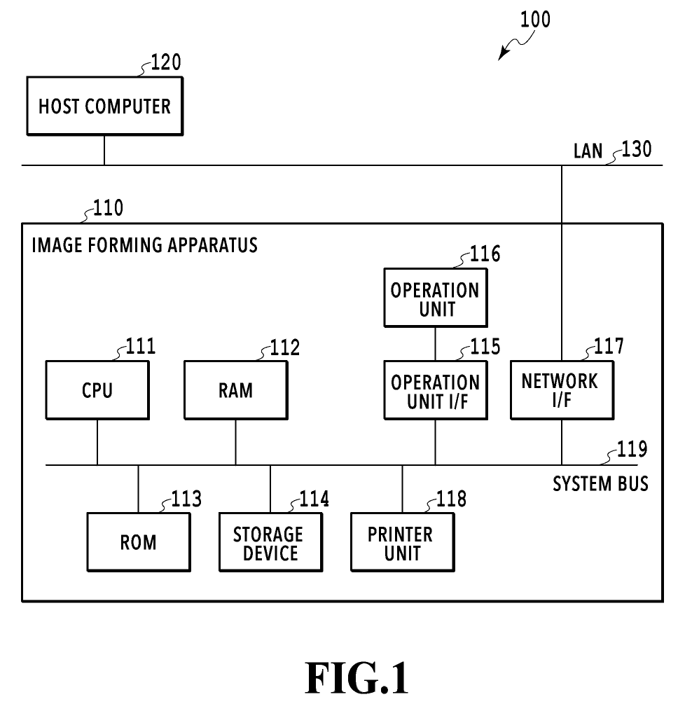

FIG. 1 is a block diagram illustrating a configuration example of an image forming system according to the present embodiment. The image forming system 100 of the present embodiment includes an image forming apparatus 110 and an host computer 120. The image forming apparatus 110 and the host computer 120 are connected via a LAN (Local Area Network) 130 so as to be able to communicate with each other. The host computer 120 is a general-purpose computer that includes standard components such as a CPU, memory, network interface, and keyboard. The host computer 120 transmits print data generated by a user operation to the image forming apparatus 110 via the LAN 130. The image forming apparatus 110 is a multifunction printer (MFP) that has multiple functions such as faxing, copying, printing, and scanning. Note that, the image forming apparatus 110 may be an SFP (Single Function Printer) that has only a printing function. Further, the image forming apparatus 110 may be a printer other than an MFP or an SFP.

### Hardware Configuration of Image Forming Apparatus

With reference to FIG. 1, a description is given of a hardware configuration example of an image forming apparatus 110 of the present embodiment. The image forming apparatus 110 includes a CPU 111, a RAM 112, a ROM 113, a storage device 114, a operation unit I/F 115, an operation unit 116, a network I/F 117, a printer unit 118, and a system bus 119.

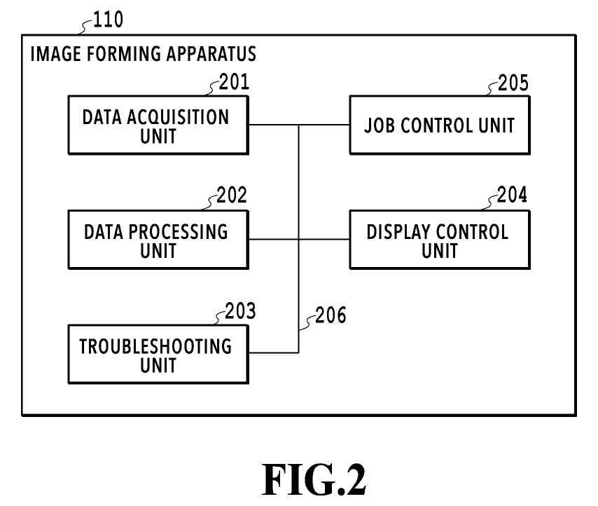

The CPU 111 is a central processing unit of the image forming apparatus 110, and comprehensively controls each device connected to a system bus 119. The RAM 112 is a storage device accessible by the CPU 111, and in the present embodiment, is used as a work memory for the CPU 111 to operate. The ROM 113 stores programs. The CPU 111 loads a program stored in the ROM 113 onto the RAM 112 and executes it, thereby operating each of the later-described software modules illustrated in FIG. 2. The storage device 114 is, for example, a hard disk drive (HDD), and stores system software for various processes, acquired print data, and the like. The storage device 114 is not limited to an HDD, but may also be an SSD (Solid State Drive), a flash memory, a cloud storage, or the like.

The operation unit I/F 115 is an interface unit for the operation unit 116, and includes a display unit for displaying various menus, information related to print data for which a print instruction has been received, etc. Operation screen data is output to the operation unit 116. Further, the operation unit I/F 115 transmits, to the CPU 111, information input by the user via the operation unit 116. The display unit may be a touch panel (a display device) that displays a user interface screen (UI screen). The operation unit 116 may accept user input via soft buttons displayed on a UI screen displayed on the display unit, or may accept user input via hard buttons.

The network I/F 117 is an interface for exchanging information with an external device (for example, the host computer 120 ) via the LAN 130. Note that, in the present embodiment, it is assumed that PDL (Page Description Language) data is received as print data from an external device. The printer unit 118 is a print engine that performs printing on a print medium such as paper in accordance with PDL data interpreted by the CPU 111.

### Software Configuration of the Image Forming Apparatus 110

FIG. 2 is a diagram illustrating an example of a software configuration of the image forming apparatus 110. The image forming apparatus 110 includes a data acquisition unit 201, a data processing unit 202, a troubleshooting unit 203, a display control unit 204, and a job control unit 205. As described above, the CPU 111 causes these software modules to operate by executing programs loaded from the ROM 113 onto the RAM 112.

The data acquisition unit 201 acquires PDL data. The data processing unit 202 interprets acquired PDL data and generates image data in a raster format. Further, the data processing unit 202 stores information about PDL data, information about a print result, or the like in the storage device 114 as a job log. The troubleshooting unit 203 narrows down solution candidates for an issue, based on issue information and a job log.

The display control unit 204 displays solution candidates on the operation unit 116. Further, the display control unit 204 displays details of a solution on the operation unit 116, based on a selected solution candidate. The job control unit 205 passes PDL data acquired by the data acquisition unit 201 to the data processing unit 202, and transfers image data in a raster format generated by the data processing unit 202 to the printer unit 118, thereby performing printing.

### Job Log Storing Process

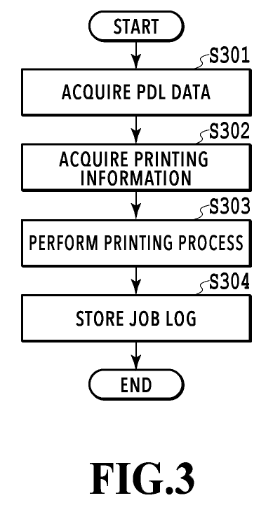

FIG. 3 is a flowchart illustrating a flow of a storing process for the job log. The series of processes illustrated in FIG. 3 is implemented by the CPU 111 of the image forming apparatus 110 loading a program stored in the ROM 113 or the storage device 114 onto the RAM 112 and executing it. Alternatively, part or all of the functions in the steps of FIG. 3 may be implemented by hardware such as an ASIC or an electronic circuit. Further, the processing of FIG. 3 starts in a case where the execution of a print job starts.

In S301, the CPU 111 acquires received PDL data via the network I/F 117. The acquisition of PDL data is not limited to a configuration in which PDL data received from an external device of the image forming apparatus 110 is acquired, but may also be a configuration in which PDL data stored in the storage device 114 of the image forming apparatus 110 is acquired.

In S302, the CPU 111 acquires printing information. Printing information is information related to the acquired PDL data, and is information required for the printing process of the PDL data, or information to be recorded in a job log. The printing information includes, for example, information about the OS (Operating System), driver, and application used in creating the PDL data. The printing information includes driver setting information that indicates the paper size, paper type, page layout, and the like. The printing information further includes device setting information that indicates halftone, thickness adjustment, etc., stored in the storage device 114 of the image forming apparatus 110. The process of acquiring printing information is a conventional technique, and thus a detailed description thereof is omitted. By analyzing the PDL data, the printing information is acquired from the print settings attached to the PDL data. Alternatively, the printing information is acquired from print settings stored in the storage device 114 of the image forming apparatus 110. Further, as a method for acquiring the OS and application information used in creating the PDL data, the OS and application information may be attached to the PDL data so as to be acquired from the PDL data. As another method, the OS and application information may be acquired via the network I/F 104, separately from the PDL data.

In S303, the CPU 111 performs printing process (the print job). The printing process is a conventional technique, and thus a detailed description is omitted. In the printing process, the CPU 111 first analyzes the acquired PDL data, and generates intermediate data for the number of pages. Next, the CPU 111 performs an image forming process for conversion into an image in a raster format by executing RIP (Raster Image Processor) processing based on the generated intermediate data. Thereafter, the CPU 111 performs the image processing on the raster-format image, and the printer unit 118 prints the rasterized image obtained as a result of the image processing on a print medium.

In S304, the CPU 111 performs a job log storing process. In the job log storing process, information related to the PDL data for which printing process has been performed is stored in the storage device 114 as a job log. The CPU 111 constructs a job log database (a job log DB) in the storage device 114, and stores the created job log together with past job logs in the job log DB.

### Job Log DB

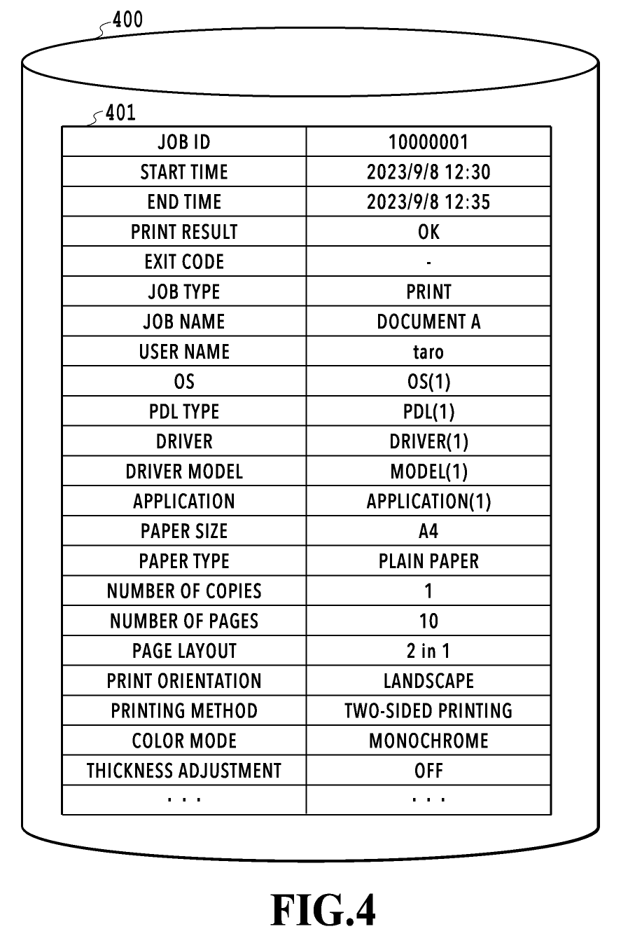

FIG. 4 is a diagram illustrating an example of a job log DB and a job log. In a job log DB 400, a job log such as a job log 401 is stored for each job. The job log 401 includes information acquired before the start of printing process, the results of printing, etc. Specifically, the job log 401 includes information related to the following items. The job log 401 includes information related job ID, start time, end time, print result, exit code, job type, job name, user name, OS, PDL type, driver, driver model, and application. The job log 401 further includes information related paper size, paper type, number of copies, number of pages, page layout, print orientation, printing method, color mode, thickness adjustment, etc.

Job ID is a unique value that identifies the job executed by the image forming apparatus 110. Start time is the time at which the printing process started. End time is the time at which the printing process ended. Print result is a value indicating the result of the printing process, and is OK if the processing ended normally, and NG if the processing ended abnormally. Exit code is an identification number for checking an error message in a case where the print result is NG. In a case where the print result is OK, the exit code is indicated as "-".

Job type indicates the type of job executed by the image forming apparatus 110, such as fax, copy, print, or scan.

Job name indicates the name of a printed file. User name indicates the name of the user who executed the printing. OS indicates the OS (Operating System) of the terminal on which the user executed the printing, such as OS(1), OS(2), etc.

PDL type indicates the type of PDL data, such as PDL(1), PDL(2), etc. Driver indicates the name of the driver used for printing. In a case where no driver was used due to direct printing, it is indicated as "-". Driver model indicates the model applied to the driver used for printing. Application indicates the name of the application that executed the print job.

Paper size indicates the paper size, such as A4, B4, postcard, etc. Paper type indicates the paper type, such as plain paper, cardboard, envelope, etc. Number of copies indicates how many print products having the same contents are to be printed. Number of pages indicates the number of pages of the PDL data. Page layout indicates settings, such as aggregate printing. Print orientation indicates the setting of portrait or landscape. Printing method indicates the setting of one-sided printing or two-sided printing.

Color mode indicates the color setting, such as color, monochrome, or automatic. Thickness adjustment indicates the setting for thickening characters, lines, graphics, or the like.

The above-described items are merely examples, and are not limited thereto. The job log DB 400 stores a job log of each job. A job log of a print job is used to display a job history, to troubleshoot a printing issue, and the like. A job log is different from PDL data. A job log is information necessary for displaying a job history, troubleshooting a printing issue, or the like, which is acquired from PDL data and device settings and stored in the storage device 114 as log information. PDL data is composed of commands such as drawing information for generating an image of each page (drawing information such as characters, figures, and images) and layout information (layout information such as a paper size and one-sided/two-sided printing). Printing can be executed by analyzing PDL data and converting it into an image in a raster format.

### Troubleshooting Process for a Printing Issue

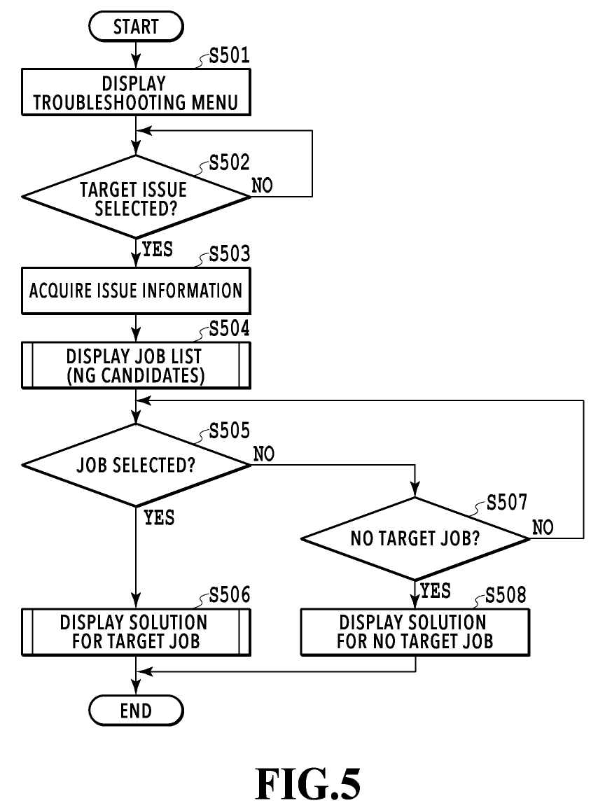

FIG. 5 is a flowchart illustrating the flow of a troubleshooting process for a printing issue. The series of processes illustrated in FIG. 5 is implemented by the CPU 111 of the image forming apparatus 110 loading a program stored in the ROM 113 or the storage device 114 onto the RAM 112 and executing it. Alternatively, part or all of the functions in the steps of FIG. 5 may be implemented by hardware such as an ASIC or an electronic circuit.

In S501, the CPU 111 displays a troubleshooting menu screen on the operation unit 116 in order to troubleshoot an issue and thereby solve the issue more properly.

### Troubleshooting Menu Screen

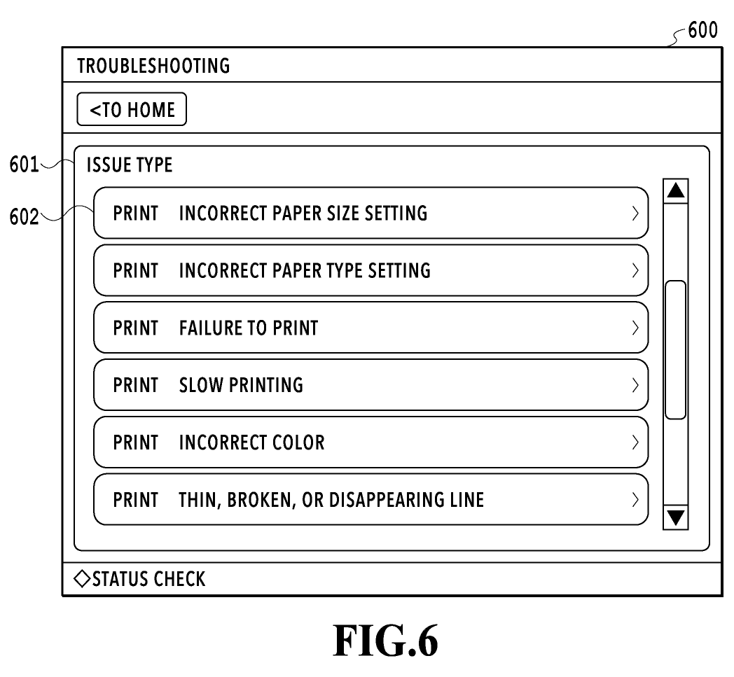

FIG. 6 is a diagram illustrating an example of a troubleshooting menu screen. A troubleshooting menu screen 600 is a top screen for troubleshooting a job in which an issue has occurred, and includes an issue type display area 601. In the issue type display area 601, a plurality of troubleshoot menu buttons 602 is displayed so as to be selectable by a user operation, for each function and each symptom of issue. In FIG. 6, as the troubleshoot menu buttons 602, "PRINT INCORRECT PRINT PAPER SIZE SETTING", "PRINT INCORRECT PAPER TYPE SETTING", "PRINT FAILURE TO PRINT", and "PRINT SLOW PRINTING" are displayed. Furthermore, as the troubleshoot menu buttons 602, "PRINT INCORRECT COLOR" and "PRINT THIN, BROKEN, OR DISAPPEARING LINE" are displayed.

In S502, the CPU 111 determines whether an issue to be troubleshot has been selected in the troubleshooting menu screen 600. Specifically, whether any one of the multiple troubleshoot menu buttons 602 displayed in the issue type display area 601 has been selected is determined. If it is determined that an issue to be troubleshot has been selected by a user operation of pressing any one of the troubleshoot menu buttons 602 (YES in S502), the processing proceeds to S503. If it is determined that an issue to be troubleshot has not been selected without a user operation of pressing any one of the troubleshoot menu buttons 602 (NO in S502), the determination process of S502 is executed again. A standby state is maintained until an issue to be troubleshot is selected.

In S503, the CPU 111 acquires issue information related to the issue selected in S502.

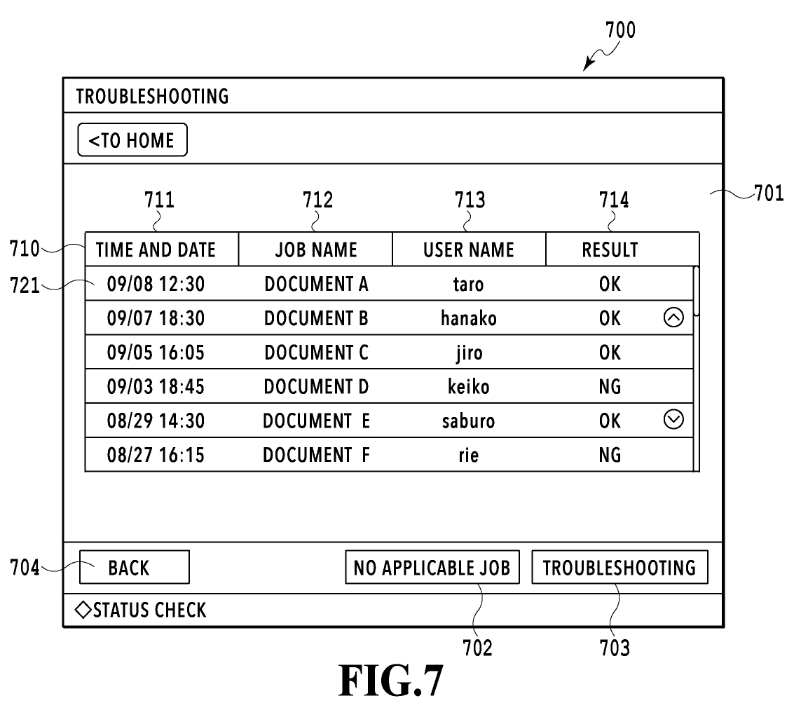

In S504, the CPU 111 generates and displays a job list (NG candidates) based on the issue information acquired in S503. The details of the process (S504) of displaying the job list (NG candidates) are described later with reference to FIGS. 7 to FIG. 9.

In S505, the CPU 111 determines whether a job to be troubleshot has been selected from the job list (NG candidates). If it is determined that a job to be troubleshot has been selected (YES in S505), the processing proceeds to S506. If it is determined that a job to be troubleshot has not been selected (NO in S505), the processing proceeds to S507.

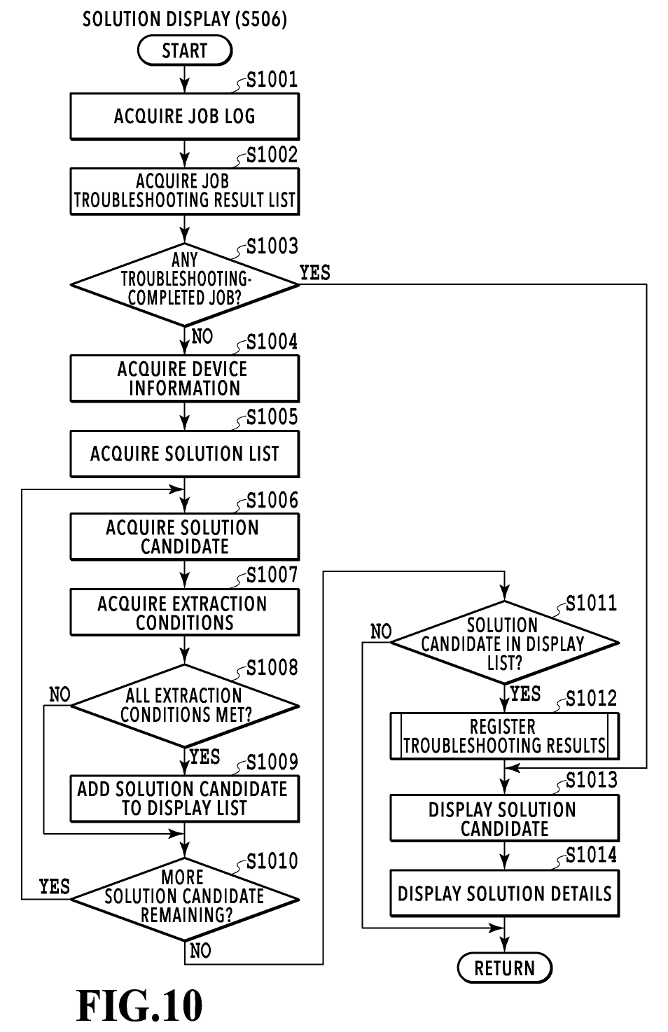

In S506, the CPU 111 performs a process of troubleshooting the contents of the selected job and displaying an appropriate solution. The details of the process (S506) of displaying a solution for a troubleshooting target job are described later with reference to FIGS. 10 to FIG. 18.

In S507, the CPU 111 determines whether a job to be troubleshot is present. If it is determined that a job to be troubleshot is present (NO in S507), the processing returns to S505. If it is determined that no job to be troubleshot is present (YES in S507), the processing proceeds to S508.

In S508, the CPU 111 performs a process of displaying a solution in a case where a troubleshooting target job is not present. The CPU 111 displays, for example, a pop-up screen including a message indicating that there is no job to be troubleshot.

A detailed description is herein given about the above-mentioned process (S504) of displaying a job list (NG candidates). As an example for the explanation, with reference to FIGS. 7 to FIG. 9, a description is given about displaying of a job list (NG candidates) in a case where the troubleshoot menu button 602 of "INCORRECT PAPER SIZE SETTING" in the "PRINT" function has been pressed.

### Screen of a Job List NG Candidates for a Printing Issue

FIG. 7 is a diagram illustrating an example of a screen displaying a job list (NG candidates) for a printing issue. The screen 700 displaying a job list of a printing issue (hereinafter referred to as the NG candidate list screen) is a screen displayed on the operation unit 116, in which a job list corresponding to the troubleshooting-target item selected by a user operation from among the multiple items displayed on the troubleshooting menu screen 600 is displayed.

The NG candidate list screen 700 is a UI screen in which each troubleshooting target job is associated with the troubleshooting result of the job, and includes the display part 701, the no applicable job button 702, the troubleshoot button 703, and the back button 704. In the display part 701, the job list (NG candidate list) 710 including a plurality of jobs 721 that can be selected by a user operation. In the job list (NG candidate list) 710, the details of each job 721 are displayed. In FIG. 7, each job 721 is displayed in association with information related to items including time and date 711, job name 712, user name 713, and result 714. The items 711 to 714 illustrated in the job list (NG candidate list) 710 are the same as the items illustrated in the job log DB. That is, time and date 711 indicates the time and date at which a job was executed. In FIG. 7, time and date 711 is indicated in the format of Month/Day HH:MM. Job name 712 indicates the name of a printed file. User name 713 indicates the name of the user who executed printing. Result 714 indicates the result of executing a job. "OK" indicates that the execution of a job ended normally. "NG" indicates that the execution of a job ended abnormally.

The no applicable job button 702 is a button to be pressed by a user operation in a case where no job to be troubleshot is present. Note that the no applicable job button 702 may not be displayed depending on the contents of issues.

The troubleshoot button 703 is a button to be pressed in a case where a job to be troubleshot is present and a job to be troubleshot is selected by a user operation. The back button 704 is a button to be pressed by a user operation to cancel the selection of a job to be troubleshot, which has been made on the screen for selecting a job to troubleshooting, and return to the previous screen.

### Process S504 of Displaying a Job List NG Candidates

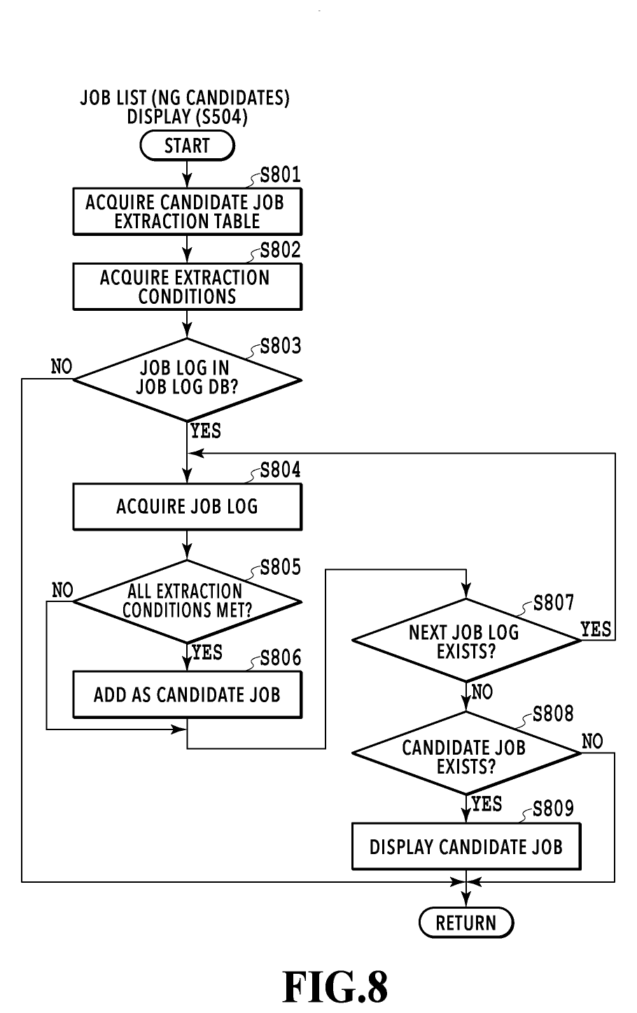

FIG. 8 is a flowchart illustrating a detailed flow of the process (S504) for displaying a job list (NG candidates) for a printing issue. The series of processes illustrated in FIG. 8 is implemented by the CPU 111 of the image forming apparatus 110 loading a program stored in the ROM 113 or the storage device 114 onto the RAM 112 and executing it. Alternatively, part or all of the functions in the steps of FIG. 8 may be implemented by hardware such as an ASIC or an electronic circuit.

In S801, the CPU 111 acquires a candidate job extraction table.

### Candidate Job Extraction Table

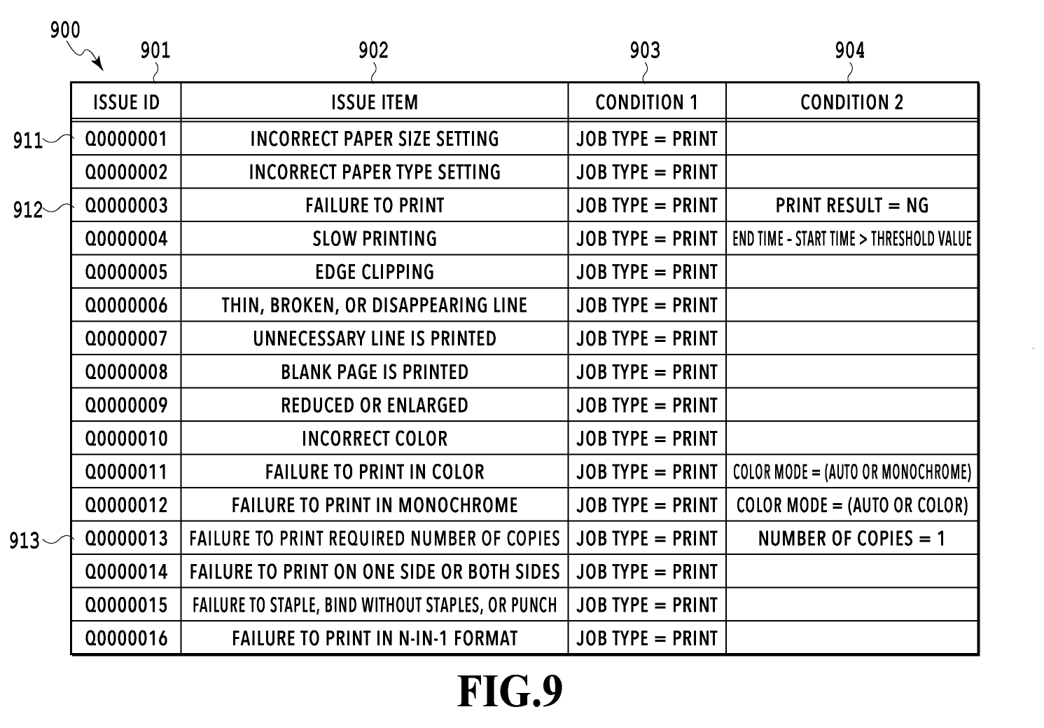

FIG. 9 is a diagram illustrating a candidate job extraction table. The candidate job extraction table 900 manages information indicated as each of the following items in association with each other: issue ID 901, issue item 902, condition1 903, and condition2 904. For example, the candidate job 911, whose issue ID 901 is "Q0000001", is associated with "INCORRECT PAPER SIZE SETTING" as the issue item 902, and "JOB TYPE = PRINT" as the condition1 903. The candidate job 912, whose issue ID 901 is "Q0000003", is associated with "FAILURE TO PRINT" as the issue item 902, "JOB TYPE = PRINT" as the condition1 903, and "PRINT RESULT = NG" as the condition2 904. The candidate job 913, whose issue ID 901 is "Q0000013", is associated with "FAILURE TO PRINT REQUIRED NUMBER OF COPIES" as the issue item 902, "JOB TYPE = PRINT" as the condition1 903, and "NUMBER OF COPIES = 1" as the condition2 904.

In S802, the CPU 111 acquires, from the candidate job extraction table acquired in S801, the extraction conditions of the candidate job that is managed by the same issue ID as the issue to be troubleshot. If the pressing of the troubleshoot menu button 602 of "INCORRECT PAPER SIZE SETTING" is detected, the extraction condition of the following candidate job is acquired from the candidate job extraction table that has been acquired. "JOB TYPE = PRINT" of the condition 1903, which is managed in the candidate job 911 whose issue ID 901 is "Q0000001", is acquired as the extraction condition. That is, the extraction condition for the candidate jobs corresponding to "INCORRECT PAPER SIZE SETTING" is a job whose value indicating its job type matches "PRINT". If the pressing of a menu button (not illustrated in the drawings) of "FAILURE TO PRINT REQUIRED NUMBER OF COPIES" is detected, the extraction conditions of the following candidate job are acquired from the candidate job extraction table that has been acquired. "JOB TYPE = PRINT" of the condition 1903 and "NUMBER OF COPIES = 1" of the condition 2904, which are managed in the candidate job 913 whose issue ID 901 is "Q0000013", are acquired as the extraction conditions. That is, the extraction conditions for the candidate jobs corresponding to "FAILURE TO PRINT REQUIRED NUMBER OF COPIES" are a job whose value indicating its job type matches "PRINT" and a job whose value indicating the number of copies matches "1".

In S803, the CPU 111 checks whether any job log is present in the job log DB. If it is confirmed that one or more job logs are present (YES in S803), the processing proceeds to S804. If it is confirmed that no job log is present (NO in S803), there are no candidate jobs to be displayed, and thus the flow illustrated in FIG. 8 ends.

In S804, the CPU 111 acquires one job log from the job log DB 400. In S805, the CPU 111 checks whether the acquired job log meets all of the extraction conditions acquired in S802. If it is confirmed that all of the extraction conditions are met (YES in S805), the processing proceeds to S806. If it is confirmed that the extraction conditions are not met (NO in S805), the processing proceeds to S807.

In S806, the CPU 111 adds the job that meets all of the extraction conditions as a candidate job. For example, since the extraction condition of the candidate job 911 representing "INCORRECT PAPER SIZE SETTING" is a job whose value indicating its job type matches "PRINT", the job log 401 meets the extraction condition, and thus the job log 401 is added as a candidate job.

In S807, the CPU 111 checks whether any job log that has not been compared with the extraction conditions acquired in S802 is present in the job log DB. If it is confirmed that a job log that has not been compared is present (YES in S807), the processing returns to S804. Then, the new job log is acquired (S804), and the processes of S805 and S806 are executed. If it is confirmed that a job log that has not been compared is not present (NO in S807), the processing proceeds to S808.

In S808, the CPU 111 checks whether a candidate job that meets the extraction conditions acquired in S802 is present in the job log DB. If it is confirmed that a candidate job is present (YES in S808), the processing proceeds to S809. In S809, the CPU 111 displays, on the operation unit 116, the NG candidate list screen 700 in which the job list (NG candidates) 710 including the added candidate jobs is displayed in the display part 701. If it is confirmed that no candidate job is present (NO in S808), there are no candidate jobs to be displayed, and thus displaying is not performed and the flow illustrated in FIG. 8 ends.

Although the example is herein described in which the candidate job 911 whose issue item 902 is "INCORRECT PAPER SIZE SETTING" is added to the job list (NG candidates), the addition method in a case where another issue is selected is similar. For example, in a case where the menu button of "FAILURE TO PRINT REQUIRED NUMBER OF COPIES" is selected, the extraction is performed according to the extraction conditions of the candidate job 913 whose issue item 902 is "FAILURE TO PRINT REQUIRED NUMBER OF COPIES". All jobs that match a job whose value indicating its job type is "PRINT" and whose value indicating the number of copies is "1" are acquired from the job log DB 400 as candidate jobs, and a job list (NG candidates) including all the acquired candidate jobs is displayed.

In this way, candidate jobs are extracted (added) according to the conditions in the candidate job extraction table 900 in FIG. 9. However, although the extraction method using the conditions associated with each issue is described, there is no such limitation. For example, candidate jobs may be extracted according to conditions not associated with issues, such as extracting candidate jobs from the most recent 50 jobs or from jobs received from a logged-in user. Further, the conditions associated with each issue are also not limited to the above-described examples.

Next, with reference to FIGS. 10 to FIG. 18, the details of the process (S506) of displaying solutions that are executed in a case where a job to be troubleshot is present is described. Here, a description is given of an example in which the issue information of the troubleshoot menu button 602 "INCORRECT PAPER SIZE SETTING" and the job 721 are selected.

### Process S506 of Displaying Solutions

FIG. 10 is a flowchart illustrating a detailed flow of the process (S506) of displaying solutions for a target job. In the flow illustrated in FIG. 10, solution candidates are narrowed down for an issue, based on selected issue information and a job. The flow illustrated in FIG. 10 starts if the issue of the troubleshoot menu button 602 "INCORRECT PAPER SIZE SETTING" is selected and then, while the job 721 is selected, pressing of the troubleshoot button 703 by a user operation is detected. The series of processes illustrated in FIG. 10 is implemented by the CPU 111 of the image forming apparatus 110 loading a program stored in the ROM 113 or the storage device 114 onto the RAM 112 and executing it. Alternatively, part or all of the functions in the steps of FIG. 10 may be implemented by hardware such as an ASIC or an electronic circuit.

In S1001, the CPU 111 acquires the job logs corresponding to the selected job. Here, it is assumed that the job log 401 corresponding to the job 721 is acquired. In S1002, the CPU 111 acquires the job troubleshooting execution result list, which indicates the results of execution of troubleshooting for jobs.

### Job Troubleshooting Execution Result List

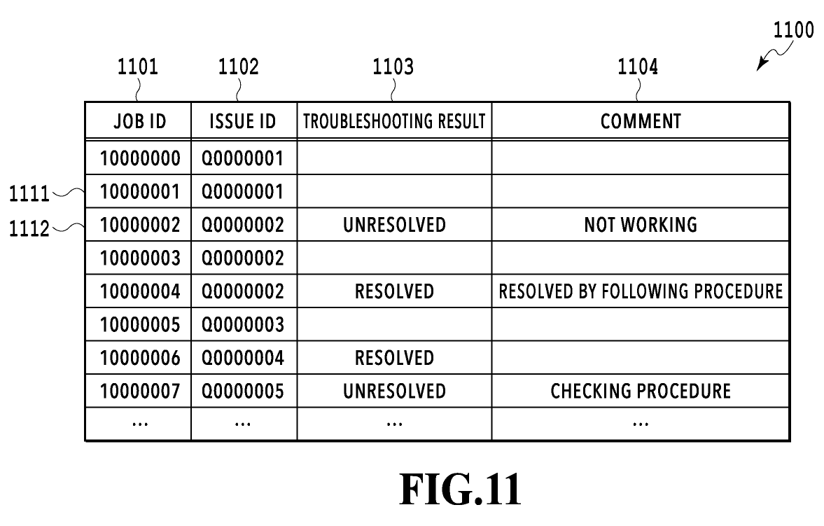

FIG. 11 is a diagram illustrating a job troubleshooting execution result list. The troubleshooting execution result list 1100 manages information indicated as each of the following items in association with each other: job ID 1101, issue ID 1102, troubleshooting result 1103, and comment 1104. For example, the job 1111, whose job ID 1101 is "10000001", is managed in association with the issue ID 1102 of "Q0000001," the troubleshooting result 1103 of "-," and the comment 1104 of "-". The job 1112, whose job ID 1101 is "10000002", is managed in association with the issue ID 1102 of "Q0000002," the troubleshooting result 1103 of "UNRESOLVED," and the comment 1104 of "NOT WORKING".

Returning to FIG. 10, the description continues. In S1003, the CPU 111 refers to the job troubleshooting result list to check whether a troubleshooting-completed job corresponding to the job 721 is present. Specifically, the CPU 111 determines that a troubleshooting-completed job is present if the troubleshooting execution result associated with the same job ID as the job ID of the acquired job log is "UNRESOLVED" or "RESOLVED," and determines that no troubleshooting-completed job is present if the result is blank. If it is determined that no troubleshooting-completed job is present (NO in S1003), the processing proceeds to S1004. If it is determined that a troubleshooting-completed job is present (YES in S1003), the processing proceeds to S1013. That is, in a case where the troubleshooting has already been performed, only the displaying of solution candidates and solution details, which are described in detail later, is performed.

In S1004, the CPU 111 acquires the device information of the image forming apparatus 110. The device information is information about the image forming apparatus 110 at the time of troubleshooting (the current time), and, for example, is information indicating the size, type, and the like of the paper set in a cassette of the sheet feeder. In S1005, the CPU 111 acquires a solution list for printing issues.

### Printing Issue Solution List

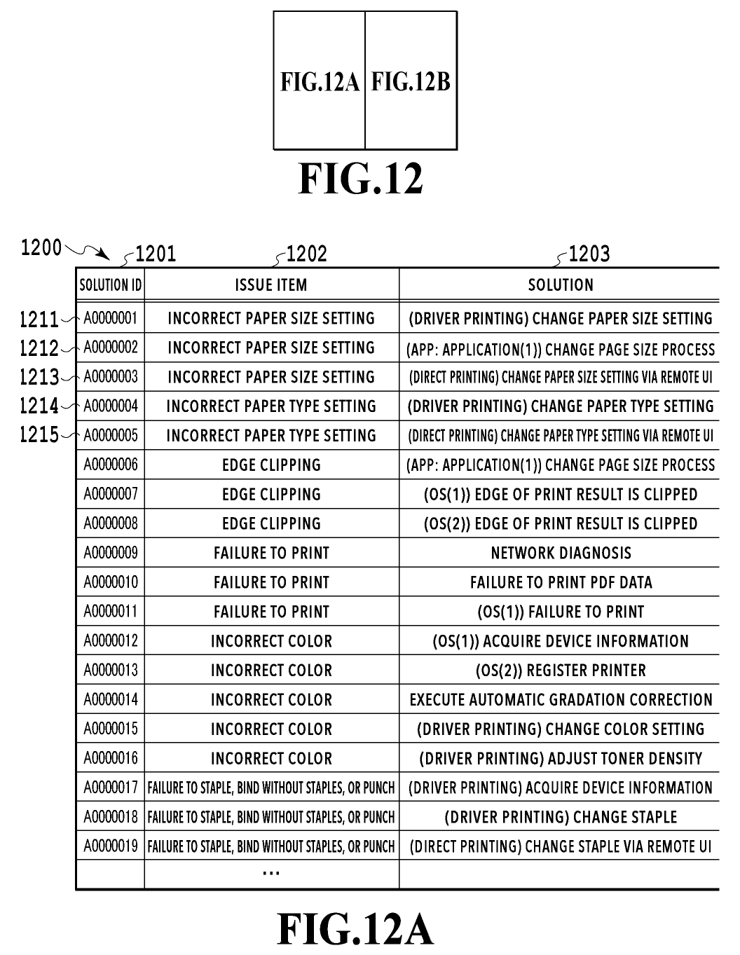

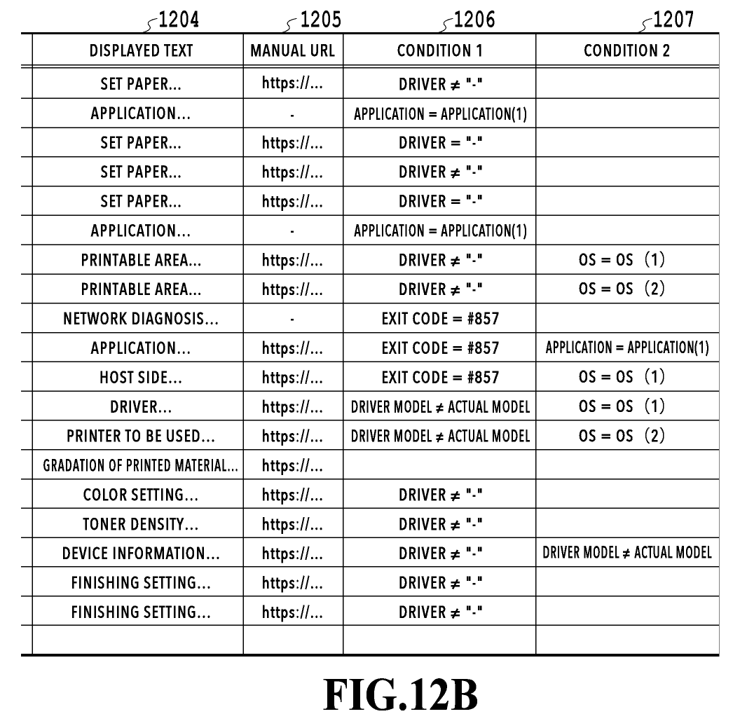

FIGS. 12A and 12B are diagrams illustrating a list of solutions to printing issues. In the solution list 1200 for printing issues, information indicated as each of the following items is managed in association with each other: solution ID 1201, issue item 1202, solution 1203, displayed text 1204, manual URL 1205, condition 11206, and condition 21207. For example, the solution ID 1201 "A0000001" is managed in association with the issue item 1202 "INCORRECT PAPER SIZE SETTING", the solution 1203 "(DRIVER PRINTING) CHANGE PAPER SIZE SETTING", and the displayed text 1204 "SET PAPER...". The solution ID 1201 "A0000001" is managed further in association with the manual URL 1205 "https://..." and the condition 1 1206 "DRIVER ≠ "-"". The solution ID 1201 "A0000007" is managed in association with the issue item 1202 "EDGE CLIPPING", the solution 1203 "(OS(1)) EDGE OF PRINT RESULT IS CLIPPED", and the displayed text 1204 "PRINTABLE AREA...". The solution ID 1201 "A0000007" is managed further in association with the manual URL 1205 "https://...", the condition 1 1206 "DRIVER ≠ "-"", and the condition 21207 "OS = OS(1)". Note that the solutions list 1200 for printing issues is not limited to the information illustrated in the above-mentioned items 1201 to 1207, and may be managed in association with information different from the information illustrated in the displayed text 1204, for example.

Returning to FIG. 10, the description continues. In S1006, the CPU 111 acquires one solution candidate from the solution list acquired in S1005. In S1007, the CPU 111 acquires extraction conditions for determining whether to extract the solution candidate.

In S1008, the CPU 111 checks whether the job log 401 acquired in S1001 meets all of the extraction conditions acquired in S1007. If it is confirmed that all of the extraction conditions are met (YES in S1008), the processing proceeds to S1009. In S1009, the CPU 111 adds the solution candidate to the display list. If it is confirmed that the extraction conditions are not met (NO in S1008), the processing proceeds to S1010.

In S1010, the CPU 111 checks whether any solution candidates that have not been compared with the job log are present in the solution list acquired in S1005. If it is confirmed that a solution candidate that has not been compared is present (YES in S1010), the processing returns to S1006. Then, the new solution candidate is acquired (S1006), and the processes from S1007 to S1009 are executed. If it is confirmed that a solution candidate that has not been compared is not present (NO in S1010), the processing proceeds to S1011.

For example, in the case of the issue information corresponding to the menu button "INCORRECT PAPER SIZE SETTING", the three solution candidates 1211, 1212, and 1213 are applicable in the solution list 1200 for printing issues. The job log 401 is compared with the extraction conditions 1206 of the three solution candidates 1211, 1212, and 1213, respectively. In the solution candidate 1211, the extraction condition for the solution 1203 "(DRIVER PRINTING) CHANGE PAPER SIZE SETTING" is the condition 1 1206 "DRIVER ≠ "-"". The job log 401 contains "DRIVER = DRIVER(1)", which satisfies the condition 11206. Therefore, the solution candidate 1211 is added to the display list.

In the next solution candidate 1212, the extraction condition for the solution 1203 "(APP: APPLICATION(1)) CHANGE PAGE SIZE PROCESS" is the condition 1 1206 "APPLICATION = APPLICATION(1)". The job log 401 contains "APPLICATION = APPLICATION(1)", which satisfies the condition 1. Therefore, the solution candidate 1212 is added to the display list.

Furthermore, in the next solution candidate 1213, the extraction condition for the solution 1203 "(DIRECT PRINTING) CHANGE PAPER SIZE SETTING VIA REMOTE UI" is the condition 1 1206 "DRIVER = "-"". The job log 401 contains "DRIVER = DRIVER(1)", which does not satisfy the condition 11206. Therefore, the solution candidate 1213 is not added to the display list.

Finally, the two solution candidates 1211 and 1212 are added to the display list.

In S1011, the CPU 111 checks whether any solution candidates is present in the display list. If it is confirmed that no solution candidate is present (NO in S1011), the flow illustrated in FIG. 10 ends. If it is confirmed that a solution candidate is present (YES in S1011), the processing proceeds to S1012.

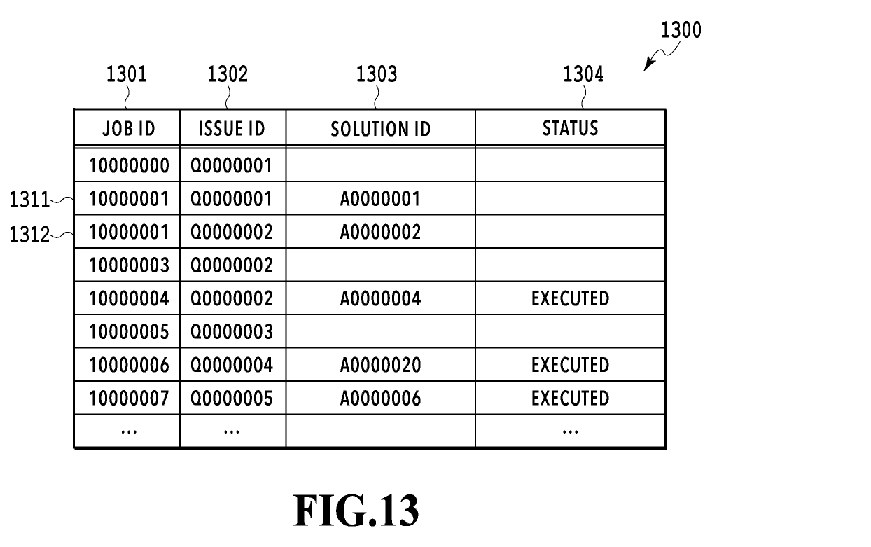

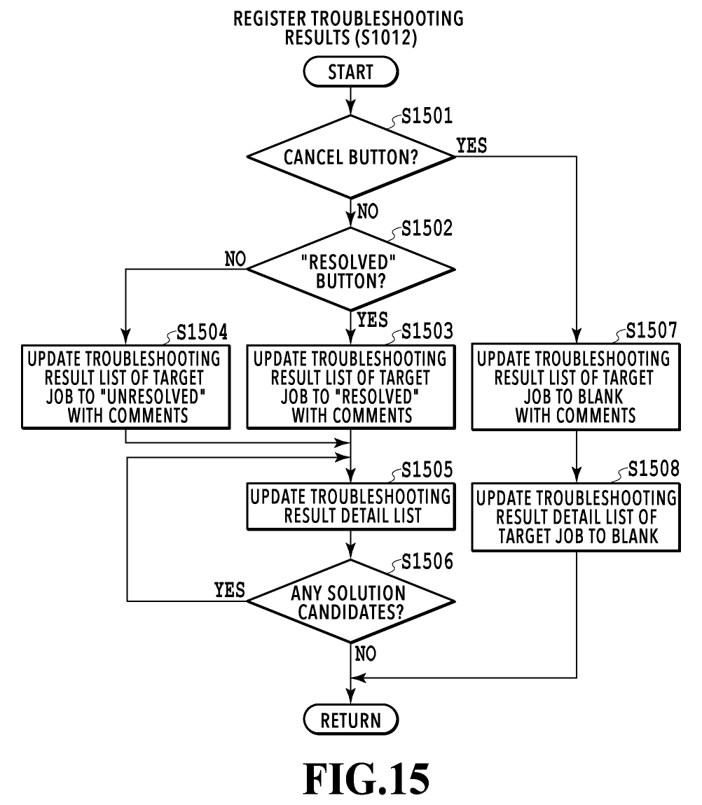

In S1012, the CPU 111 registers a new troubleshooting job in the troubleshooting execution result list 1100 and the detailed troubleshooting-result list 1300. The details of the process (S1012) of registering a troubleshooting execution result are described later with reference to FIG. 15. Here, the troubleshooting job 1111 associated with the issue ID 901 "Q0000001", which corresponds to the job ID "10000001" of the job 721 and the trouble item "INCORRECT PAPER SIZE SETTING", is registered in the troubleshooting execution result list 1100. At the time of registration, information related to the troubleshooting execution result 1103 and the comment 1104 is left blank so that the executed contents can be updated later. Note that a description is given later about the details of updating the solution information, which is information related to the troubleshooting execution result 1103 and the comment 1104 and relates to a solution implemented to resolve an issue that occurred along with execution of a job in the image forming apparatus 110. Further, at this time, in addition to the job ID and the issue ID, the solution IDs (A0000001, A0000002) corresponding to these solution candidates 1211 and 1212 are registered as two pieces of data 1311 and 1312, respectively, in the detailed troubleshooting-result list 1300 illustrated in FIG. 13. At the time of registration, the information related to the status 1304 is left blank so that the executed contents can be updated later. Note that details of updating the above-mentioned solution information including the information related to the status 1304 are described later.

### Detailed Troubleshooting-Result List

FIG. 13 is a diagram illustrating an example of a detailed troubleshooting-result list. The detailed troubleshooting-result list 1300 manages information indicated as each of the following items in association with each other: job ID 1301, issue ID 1302, solution ID 1303, status 1304. For example, the troubleshooting result 1311 whose job ID 1301 is "1000001" and whose issue ID 1302 is "Q0000001" is associated with the solution ID 1303 "A0000001". The troubleshooting result 1312 whose job ID 1301 is "1000001" and whose issue ID 1302 is "Q0000002" is associated with the solution ID 1303 "A0000002". Note that "EXECUTED" in the status 1304 indicates that the solution has been executed.

### SCREEN OF SOLUTION CANDIDATES AND DETAILS OF A SELECTED SOLUTION

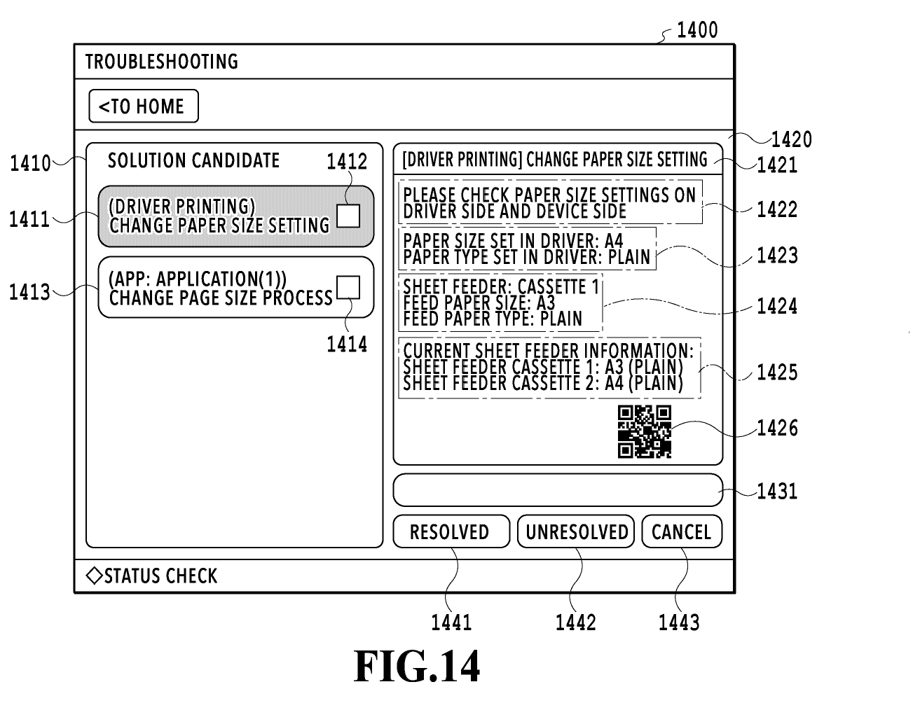

FIG. 14 is a diagram illustrating an example of a screen displaying solution candidates and details of a selected solution. Note that, in the screen 1400, a case where a job undergoes troubleshooting for the first time without any troubleshooting-completed jobs is illustrated. The screen 1400 has the solution candidate display part 1410, where the solution candidates 1411 and 1413 and the execution flags 1412 and 1414 are displayed, and the solution detail display part 1420, where the detail information 1421 of a selected solution is displayed. The screen 1400 has the execution comment input field 1431, the resolved button 1441, the unresolved button 1442, and the cancel button 1443.

Returning to FIG. 10, the description continues. In S1013, the CPU 111 displays, on the operation unit 116, the screen 1400 including the solution candidate display part 1410 where the solution candidates 1411 and 1413 are displayed. Next, if the troubleshooting unit 203 detects that a button in the solution candidate display part 1410 on the screen 1400 has been pressed by a user operation, the processing proceeds to S1014. Here, it is assumed that the pressing of the solution candidate 1411 "(DRIVER PRINTING) CHANGE PAPER SIZE SETTING" by a user operation is detected, and the processing proceeds to S1014.

In S1014, the CPU 111 displays the detail information 1421 of the solution corresponding to the selected solution candidate in the solution detail display part 1420.

Specifically, the displayed text 1422 ("DRIVER AND DEVICE SIDE..." written in the detail information 1421 of the solution in FIG. 14) of the solution candidate 1211 representing "(DRIVER PRINTING) CHANGE PAPER SIZE SETTING" in FIGS. 12A and 12B is displayed. The information of the job log acquired in S1001 ("PAPER SIZE/TYPE SET IN DRIVER" 1423 and "SHEET FEEDER CASSETTE, FEED PAPER SIZE/TYPE" 1424 written in the detail information 1421 of the solution in FIG. 14) is displayed. The device information acquired in S1002 ("CURRENT SHEET FEEDER INFORMATION: SHEET FEEDER CASSETTE 1/2" 1425 written in the detail information 1421 of the solution in FIG. 14) is displayed. Further, the image 1426 obtained by converting the manual URL into a QR code (registered trademark) is displayed. By reading the QR code image 1426, the user can correct the settings of the image forming apparatus 110 while checking solutions via a mobile device or the like.

The user can easily check the differences by comparing the paper sizes/types of the information 1423, the information 1424, and the information 1425 displayed in the solution detail display part 1420 in FIG. 14. The displayed information is merely an example, and is not limited to this.

In a case where the solution candidate 1413 is selected, the detail information about the solution associated with the solution candidate 1212 is displayed in the solution detail display part 1420.

Further, although the example in which solution candidates are extracted in a case where the issue of the menu button "INCORRECT PAPER SIZE SETTING" and the job 721 are selected is described above, even in a case where a combination of another issue and another job is selected, the method for extracting solution candidates is similar.

For example, in a case where the issue of the menu button "INCORRECT PAPER TYPE SETTING" and the job 721 are selected, the extraction is performed by comparison with the conditions of the two solution candidates 1214 and 1215 corresponding to "INCORRECT PAPER TYPE SETTING" in the solution list 1200. A comparison is made with the information in the job log 401 corresponding to the job 721, and finally, the solution candidate 1214 is added to the display list and displayed. In this way, if the issue "INCORRECT PAPER TYPE SETTING" is selected, only solution candidates for "INCORRECT PAPER TYPE SETTING" and solution candidates related to the selected job are displayed.

Whether each solution candidate has been executed can be input as the execution flags 1412 and 1414, and comments about the execution of the solutions can be freely input to the execution comment input field 1431. If the resolved button 1441 or the unresolved button 1442 is pressed by a user operation, the execution result corresponding to the pressed button is registered. If the resolved button 1441 is pressed, resolved status is registered, and if the unresolved button 1442 is pressed, unresolved status is registered. Further, once registered, if the screen 1400 is displayed again with selection of the same job, the following information is displayed. Specifically, the comment 1104 of the troubleshooting execution result list 1100 is displayed in the execution comment input field 1431, and the troubleshooting result 1103 is reflected in the resolved button 1441 or unresolved button 1442 and displayed. Further, the status (the solution execution status) 1304 of the detailed troubleshooting-result list 1300 is reflected in the execution flags 1412 and 1414 and displayed. However, in the case of a new troubleshooting, the troubleshooting execution result list 1100 and the detailed troubleshooting-result list 1300 are blank because there are no execution results. The cancel button 1443 is a button for clearing all of the registered execution result, that is, the input through the execution flags 1412 and 1414, the execution comment input field 1431, the resolved button 1441, and the unresolved button 1442. The registered contents of execution results and the display format are merely examples, and are not limited to these.

### Process S1012 of Registering a Troubleshooting Execution Result

FIG. 15 is a flowchart illustrating a detailed flow of the process (S1012) of registering a troubleshooting execution result. The flow illustrated in FIG. 15 starts if the pressing of the resolved button 1441, the unresolved button 1442, or the cancel button 1443 is detected in a state where an execution comment related to the execution result is input to the execution comment input field 1431 by a user operation in the screen 1400. The series of processes illustrated in FIG. 15 is implemented by the CPU 111 of the image forming apparatus 110 loading a program stored in the ROM 113 or the storage device 114 onto the RAM 112 and executing it. Alternatively, part or all of the functions in the steps of FIG. 15 may be implemented by hardware such as an ASIC or an electronic circuit.

In S1501, the CPU 111 determines whether the cancel button 1443 has been pressed on the screen 1400 including the solution candidates and the details of a selected solution. If it is determined that the cancel button 1443 has been pressed (YES in S1501), the processing proceeds to S1507. In S1507, the CPU 111 updates, to blank, the troubleshooting result 1103 and the comment 1104 of the troubleshooting execution result list 1100 obtained by using the combination of the job ID and the issue ID of the currently displayed solution candidate screen as a key. In S1508, the CPU 111 updates, to blank, the status 1304 of the detailed troubleshooting-result list 1300 obtained by using the combination of the job ID, the issue ID, and the solution ID as a key. Note that, if the process of S1508 is completed, the flow illustrated in FIG. 15 ends.

On the other hand, if it is determined that the cancel button 1443 has not been pressed (NO in S1501), the processing proceeds to S1502. In S1502, the CPU 111 determines whether the resolved button 1441 has been pressed. If it is determined that the resolved button 1441 has been pressed (YES in S1502), the processing proceeds to S1503. In S1503, the CPU 111 updates the troubleshooting execution result 1103 in the troubleshooting execution result list 1100 corresponding to the job ID and issue ID of the current troubleshooting target to "RESOLVED". Further, the CPU 111 updates the comment 1104 corresponding to the job ID and issue ID of the current troubleshooting target to the comment that is input in the execution comment input field 1431. Note that, if the process of S1503 is completed, the processing proceeds to S1505. On the other hand, in a case where it is determined that the resolved button 1441 has not been pressed (NO in S1502), the processing proceeds to S1504. In S1504, the CPU 111 updates the troubleshooting execution result 1103 in the troubleshooting execution result list 1100 corresponding to the job ID and issue ID of the current troubleshooting target to "UNRESOLVED". Further, the CPU 111 updates the comment 1104 corresponding to the job ID and issue ID of the current troubleshooting target to the comment that is input to the execution comment input field 1431.

In S1505, the CPU 111 updates the status 1304 in the detailed troubleshooting-result list 1300 associated with the troubleshooting results, in accordance with the check statuses of the execution flags 1412 and 1414 of the respective solution candidates. In other words, checked one is updated to "EXECUTED", and unchecked one is updated to blank.

In S1506, the CPU 111 checks whether any more solution candidate is present. If it is confirmed that any more solution candidate is present (YES in S1506), the processing returns to S1505. Then, in S1505, the detailed troubleshooting-result list 1300 is updated. If it is confirmed that no more solution candidate is present (NO in S1506), the flow illustrated in FIG. 15 ends.

### Screen of Solution Candidates and Details of a Selected Solution

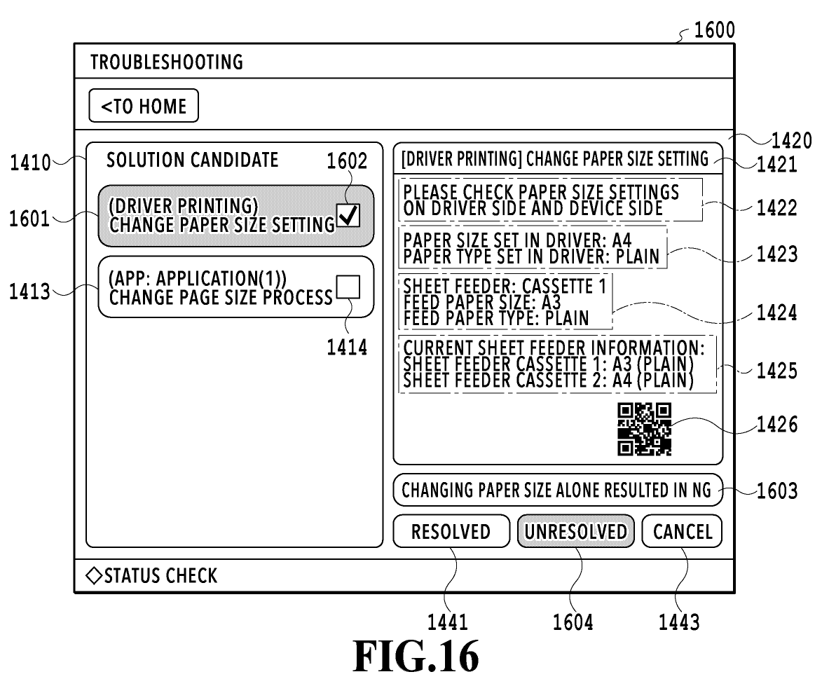

FIG. 16 is a diagram illustrating a screen displaying solution candidates and details of a selected solution. Note that the screen 1600 is a screen displayed on the operation unit 116, and a case where a troubleshooting-completed job is present is illustrated. Similarly to the screen 1400, the screen 1600 has the solution candidate display part 1410, where the solution candidate 1413 and the execution flag 1414 are displayed, and the solution detail display part 1420, where the detail information 1421 of the selected solution is displayed. The screen 1600 includes the resolved button 1441 and the cancel button 1443.

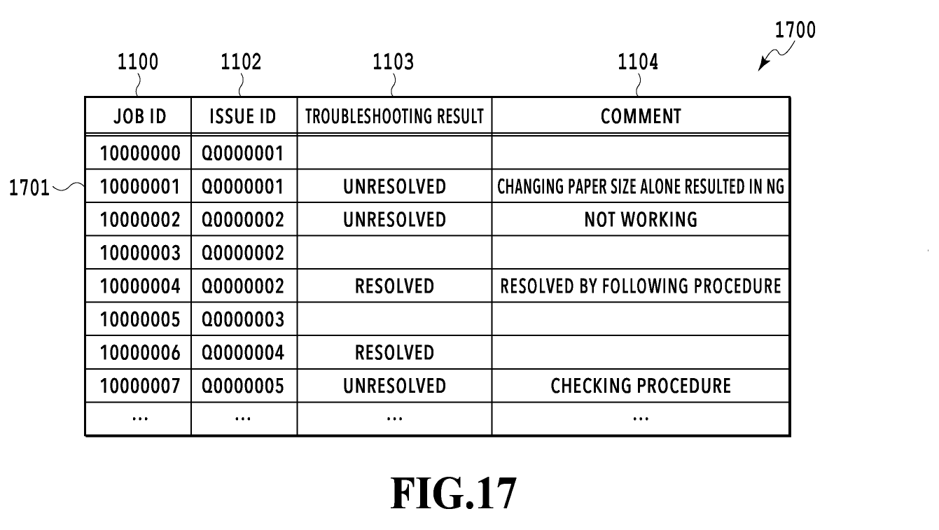

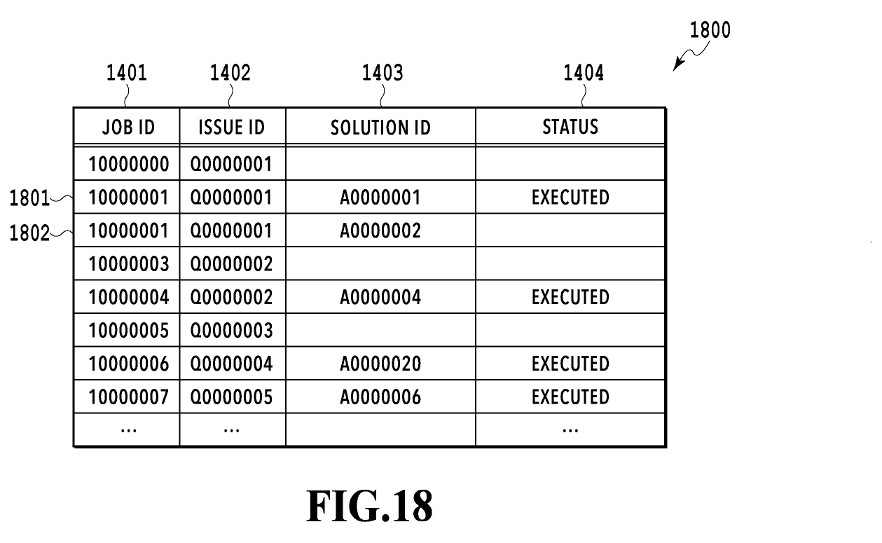

The screen 1600 indicates the state input by a user operation, and includes the solution candidate 1601, the execution flag 1602, the execution comment input field 1603, and the unresolved button 1604. Specifically, a check is entered in the execution flag 1602 of the solution candidate 1601 "CHANGE PAPER SIZE SETTING". Further, the comment "CHANGING PAPER SIZE ALONE RESULTED IN NG" is input to the execution comment input field 1603, and the unresolved button 1604 is pressed. In a case where these are input, the information associated with the troubleshooting job 1701 in the troubleshooting execution result list 1700 is updated as illustrated in FIG. 17 by the process of S1504. Specifically, the troubleshooting execution result 1103 is updated to "UNRESOLVED," and the execution comment 1104 is updated to "CHANGING PAPER SIZE ALONE RESULTED IN NG". Further, the information associated with the solution candidates 1801 and 1802 in the detailed troubleshooting-result list 1800 is updated as illustrated in FIG. 18. Specifically, in the solution candidate 1801, the status 1404 is updated to "EXECUTED", and in the solution candidate 1802, the status 1404 is updated to blank.

The new troubleshooting job is registered in the troubleshooting execution result list 1100 and the detailed troubleshooting-result list 1300 (S1012). Then, the troubleshooting execution results are updated as illustrated in the troubleshooting execution result list 1700 and the detailed troubleshooting-result list 1800 (S1503, S1504, S1505). Accordingly, in a case where the same job 721 is selected again with the issue information of the troubleshoot menu button 602 "INCORRECT PAPER SIZE SETTING", the following processing will be performed. That is, it will be determined in the process of S1003 that a troubleshooting-completed job is present (YES in S1003), and the processing proceeds to S1013 without performing the processes of S1004 to S1012. Then, information corresponding to the job ID and issue ID is acquired from the troubleshooting execution result list 1100 and the detailed troubleshooting-result list 1300, and only displaying of the solution candidates and the detail information of the solutions is performed.

As described above, in the present embodiment, the result of executing a solution for a job selected by the user is stored. Therefore, the user themselves can later check the execution status and execution result of a troubleshooting, which improves usability in troubleshooting issues that occur along with execution of a job.

However, with the technology of Japanese Patent Laid-Open No. 2012-163805, for example, in a case where an operator later looks back at job logs, the operator cannot see what solution was executed for an issue that occurred along with execution of a job or whether the issue was resolved, which results in burdensome work to solve issues.

According to the present embodiment, it is possible to provide a technology that improves usability in troubleshooting issues that occur along with execution of a job.

### Second Embodiment

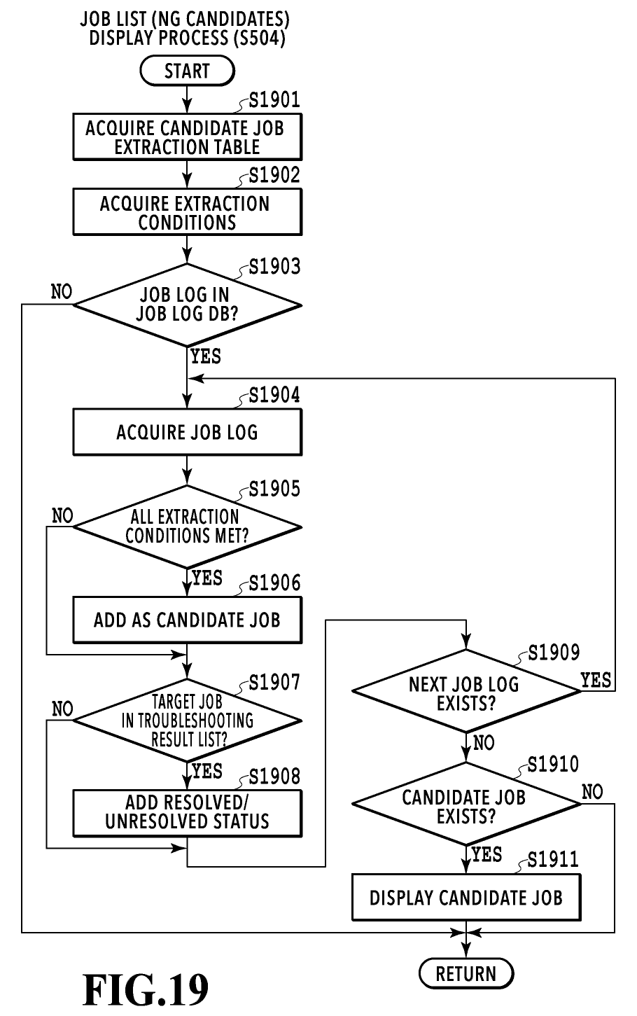

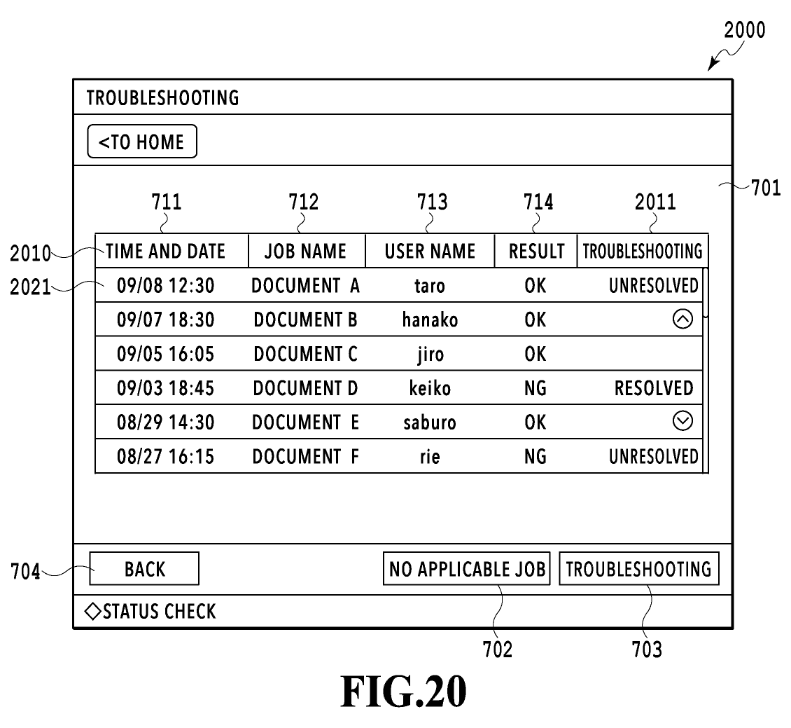

In the present embodiment, with reference to FIGS. 19 and FIG. 20, a description is given about the details of the process of displaying a job list (NG candidate list) of a printing issue such that jobs that have already been troubleshot can be identified. Note that the configuration of the image forming apparatus of the present embodiment is the same as the configuration of the image forming apparatus of the first embodiment illustrated in FIG. 1. In the present embodiment, the differences from the first embodiment are mainly described.

### Process (S504) of Displaying a Job List (NG Candidates)

FIG. 19 is a flowchart illustrating the detailed flow of the process (S504) for displaying a job list (NG candidate list) for a printing issue. The series of processes illustrated in FIG. 19 is implemented by the CPU 111 of the image forming apparatus 110 of the present embodiment loading a program stored in the ROM 113 or the storage device 114 onto the RAM 112 and executing it. Alternatively, part or all of the functions in the steps of FIG. 19 may be implemented by hardware such as an ASIC or an electronic circuit. Since S1901 to S1906 and S1909 to S1911 are the same as S801 to S806 and S807 to S809, detailed descriptions thereof are omitted. If the determination made in S1905 is NO, or if the process of S1906 is completed, the processing proceeds to S1907.

In S1907, the CPU 111 checks whether a target job (a troubleshooting-completed job) is present in the job troubleshooting execution result list. If it is confirmed that no target job is present (NO in S1907), the processing proceeds to S1909. If it is confirmed that a target job is present (YES in S1907), the processing proceeds to S1908. For example, the jobs added as candidate jobs in S1906 and the issue information of the troubleshoot menu button 602 representing "INCORRECT PAPER SIZE SETTING" are used for the comparison with the troubleshooting execution result list 1100 to check whether troubleshot data is present. If it is confirmed that troubleshot data is not present (NO in S1907), the processing proceeds to S1909. If it is confirmed that troubleshot data is present (YES in S1907), the processing proceeds to S1908.

In S1908, the CPU 111 adds the information (RESOLVED OR UNRESOLVED) indicated by the troubleshooting execution result 1103 as display information.

In the process (S1910) of determining whether a candidate job that meets the extraction conditions is present, if it is confirmed that a candidate job that meets the extraction conditions is present (YES in S1910), the processing proceeds to S1911. In S1911, the CPU 111 displays a UI screen including candidate jobs on the operation unit 116. If the process of S1911 is completed, the flow illustrated in FIG. 19 ends. Note that, in the process (S1910) of determining whether a candidate job that meets the extraction conditions is present, if it is determined that a candidate job that meets the extraction conditions is not present (NO in S1910), the flow illustrated in FIG. 19 ends.

### Screen of a Job List NG Candidates for a Printing Issue

FIG. 20 is a diagram illustrating an example of a screen displaying a job list (NG candidates) for a printing issue. The screen 2000 displaying a job list of a printing issue is a screen displayed on the operation unit 116, in which a job list that corresponds to the troubleshooting-target item selected by a user operation from among the multiple items displayed on the troubleshooting menu screen 600 is displayed. Note that the screen 2000 displaying the job list for a printing issue is hereinafter referred to as the NG candidate list screen. The NG candidate list screen 2000 is a UI screen in which a troubleshooting target job is associated with the result of troubleshooting the job.

Similarly to the NG candidate list screen 700, the NG candidate list screen 2000 is a UI screen in which a troubleshooting target job is associated with the result of troubleshooting the job, and includes a display part 701, a no applicable job button 702, a troubleshoot button 703, and a back button 704. In the display part 701, the job list (NG candidate list) 2010 is displayed. The job list (NG candidate list) 2010 displays the details of each job 2021. In FIG. 20, each job 2021 is displayed in association with information related to items including time and date 711, job name 712, user name 713, result 714, troubleshoot 2011. Troubleshoot 2011 indicates whether troubleshooting has been performed for a job, and indicates information (RESOLVED, UNRESOLVED) of the troubleshooting execution result 1103.

The example in which an issue of the candidate job 911 with the issue item 902 "INCORRECT PAPER SIZE SETTING" is extracted is herein described. In the present embodiment, for each job 2021, the information related to troubleshoot 2011 is displayed in addition to the information related to time and date 711, job name 712, user name 713, and result 714. By displaying information related to troubleshoot 2011, it is possible to immediately recognize whether troubleshooting has been performed for each job and whether each job is resolved or unresolved as a result of the troubleshoot.

Note that the method for displaying a job list (NG candidates) of a printing issue is not limited to the NG candidate list screen 2000 illustrated in FIG. 20. For example, if it is determined in S1907 that the job is resolved (YES in S1907), a job list (NG candidates) in which the resolved job has been deleted may be displayed. This allows the user to check only the NG candidates, thereby improving convenience for the user.

For example, if it is determined in S1907 that the job is unresolved (YES in S1907), NG candidate jobs in which the unresolved job is arranged at the top of the list may be displayed. This makes it unlikely to be deleted from the list even after an increase of the items displayed on the list, and thus makes it possible to provide a notification to the user more reliably, compared with the case in which the unresolved jobs are not arranged at the top.

Further, in a case where a job that was once unresolved is troubleshot again and then registered as unresolved again, the job that was not resolved after the multiple times of execution of a solution for the issue (the job that was unresolved twice) may be highlighted. The highlighting may be such that the applicable job is displayed in bold, or in colored text such as red, or the background of the applicable job may be displayed in color such as red. This makes it possible to provide a notification to the user more reliably.

As described above, according to the present embodiment, regarding a job in which an issue has occurred, it is possible to display a solution for the issue. Further, by registering the execution result of the solution for the issue, it becomes possible to immediately recognize, at a later time, whether the solution for the issue has been executed and whether the printing issue of the troubleshooting-completed job has been resolved or unresolved.

### Other Embodiments

Although the above description is given about the case in which UI screens are displayed on the operation unit of the image forming apparatus, there is no such limitation. For example, displaying on a user terminal operated by the user is also possible. In this case, the user terminal acquires information necessary for the display processes from the image forming apparatus.

Although the above description is given about the case in which the determination made in S1502 is based on the presence/absence of pressing of the resolved button 1441, there is no such limitation. For example, the determination may be made based on the presence/absence of pressing of the unresolved button 1442. In a case where the determination is made based on the presence/absence of pressing of the unresolved button 1442, if it is determined that the unresolved button 1442 has not been pressed, the processing proceeds to S1503, and if it is determined that the unresolved button 1442 has been pressed, the processing proceeds to S1504.

Although the above description is given using the example of the solution information including information related to the troubleshooting execution result 1103 and the comment 1104 and information related to the status 1304, there is no such limitation. The solution information may include at least one of the information related to the troubleshooting execution result 1103 and information related to the comment 1104. Further, the solution information may also include at least one of information related to the troubleshooting execution result 1103, information related to the comment 1104, and information related to the status 1304.

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present embodiment, it is possible to improve usability in troubleshooting issues that occur along with execution of a job.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-012071, filed January 28, 2025, which is hereby incorporated by reference wherein in its entirety.

What is claimed is:

1. An image forming apparatus comprising:
at least one memory that stores instructions; and
at least one processor that executes the instructions to:
manage solution information related to a solution implemented to resolve an issue that has occurred along with execution of a job in the image forming apparatus such that the solution information is associated with the issue; and
display, on a display unit, a troubleshooting target job so as to be selectable by a user operation among at least one job executed in the image forming apparatus,
wherein, in the displaying, the solution information associated with an issue corresponding to an issue that has occurred along with execution of the job selected by the user operation, among at least one issue managed in the managing, is displayed on the display unit.

2. The image forming apparatus according to claim 1,
wherein the solution information includes an execution result of a solution for the issue or a comment related to the execution result.

3. The image forming apparatus according to claim 1,
wherein, in the displaying, a UI screen in which the troubleshooting target job and a troubleshooting execution result of the job are associated with each other is displayed on the display unit.

4. The image forming apparatus according to claim 1,
wherein, in the displaying, control is performed such that a job that has been resolved by executing a solution for the issue is not displayed on the display unit.

5. The image forming apparatus according to claim 1,
wherein, in the displaying, control is performed such that a job that has not been resolved by executing a solution for the issue is displayed above a job that has been resolved by executing a solution for the issue.

6. The image forming apparatus according to claim 1,
wherein, in the displaying, a job that has not been resolved after a solution for the issue is executed multiple times is displayed in a highlighted manner.

7. The image forming apparatus according to claim 1,
wherein the at least one processor further executes the instructions to register the solution information.

8. The image forming apparatus according to claim 7,
wherein the at least one processor further executes the instructions to delete the solution information registered in the registering.

9. An image forming method comprising:
a managing step for managing solution information related to a solution implemented to resolve an issue that has occurred along with execution of a job in an image forming apparatus such that the solution information is associated with the issue; and
a display controlling step for displaying, on a display unit, a troubleshooting target job so as to be selectable by a user operation among at least one job executed in the image forming apparatus,
wherein, in the display controlling step, the solution information associated with an issue corresponding to an issue that has occurred along with execution of the job selected by the user operation, among at least one issue managed in the managing step, is displayed on the display unit.

10. A non-transitory computer readable storage medium storing a program for causing a computer to perform an image forming method, the image forming method comprising:
a managing step for managing solution information related to a solution implemented to resolve an issue that has occurred along with execution of a job in an image forming apparatus such that the solution information is associated with the issue; and
a display controlling step for displaying, on a display unit, a troubleshooting target job so as to be selectable by a user operation among at least one job executed in the image forming apparatus,
wherein, in the display controlling step, the solution information associated with an issue corresponding to an issue that has occurred along with execution of the job selected by the user operation, among at least one issue managed in the managing step, is displayed on the display unit.
